(19) United States
(12) Patent Application Publication
(10) Pub. No.: US 2010/0143731 A1
(43) Pub. Date: Jun. 10, 2010

(54) WATERPROOFING COATING CONTAINING LIGHT WEIGHT FILLERS

(75) Inventors: Ted DeZurik, Colfax, WI (US); Richard Patrick Lee, North Canton, OH (US)

Correspondence Address: MERCHANT & GOULD PC, P.O. BOX 2903, MINNEAPOLIS, MN, 55402-0903, US

(73) Assignee: PROTECTIVE COATINGS TECHNOLOGY, INC., Menomonie, WI (US)

(21) Appl. No.: 12/328,225

(22) Filed: Dec. 4, 2008

(51) Int. Cl. C08L 25/06; B05D 3/10; B32B 15/08; B32B 27/10; B32B 27/06

(52) U.S. Cl. 428/461; 524/577; 524/528; 427/385.5; 427/393.6; 427/388.1; 427/393; 428/513; 428/500

(57) ABSTRACT

The present invention provides a coating composition which contains an organic solvent, a polymeric binder containing a styrene-olefin polymer, and a light weight filler. Methods for preparing the coating composition, methods for using the coating composition to coat a substrate, and coated articles produced from these coating compositions are also provided.

### FIELD OF THE INVENTION

This invention relates generally to the field of coating, waterproofing, and sealing structures to prevent air and/or water penetration. In particular, the invention relates to a coating composition, and to a method of coating a substrate, such as a rigid structural unit, using the coating composition.

### BACKGROUND OF THE INVENTION

Structures used in construction, such as foundations, walls, and roofs, include materials such as masonry, cement, wood, plaster, stone, clay, or brick that may be porous. Porous materials can be susceptible to cracking and can be degraded by water and/or from loss of water from the porous materials. Below grade structures are often subjected to hydrostatic pressure from ground water. Above grade structures are subjected to precipitation, moisture migration, air and vapor penetration, and water from other sources. A variety of methods and products for coating, waterproofing, and/or sealing these structures against water and/or vapor penetration have been developed.

Many coating formulations are solvent-based and are subject to limitations on the volatile organic content (VOC) level of the formulations. Hence, it is beneficial to limit the volatility of the components in the coating composition or formulation. In addition to meeting VOC regulations, reducing volatility can reduce worker exposure and safety concerns. Reducing the density, or specific gravity, of a coating formulation may be desirable, since less weight of a lower density coating would be needed to cover the same surface area of a substrate, as compared to that achieved with a coating composition having a higher density.

While reducing the VOC level and the coating density may be important, the performance properties of the coating composition cannot be sacrificed. Ease of application at a wide range of coating thicknesses is an important criteria, whether the coating is applied by spraying, brushing, rolling, or other method. End-use performance criteria for many coating compositions include the coating barrier/permeability, coating tensile and elongational strength, and the crack-bridging characteristics of the coating. Ultimately, it is a combination of these attributes which will determine the fitness for use of the coating in a particular application.

Therefore, there is a need in the coating industry for a coating composition which has a reduced VOC level and a lower density for improved coating yield, but maintains the required application and end-use performance criteria, such as coating barrier, coating strength, and crack bridging properties. Accordingly, it is to these ends that the present invention is directed.

### SUMMARY OF THE INVENTION

The present invention discloses coating compositions, methods for preparing the coating compositions, methods for using the compositions to coat substrates, and coated articles produced from these coating compositions. Specifically, the present invention discloses solvent-based coating compositions containing light weight fillers. These coating compositions can be used for waterproofing applications, and beneficially, with reduced VOC levels. In accordance with the present invention, one such composition comprises:

(i) an organic solvent;

(ii) a polymeric binder comprising a styrene-olefin polymer; and

(iii) a light weight filler.

In another aspect, the present invention also relates to methods for coating a substrate. The substrate can be a rigid structural unit which comprises, for example, masonry or concrete. A method of coating a substrate in accordance with the present invention can comprise:

(a) applying a liquid coating composition to the substrate, wherein the liquid coating composition comprises:
(i) an organic solvent;
(ii) a polymeric binder comprising a styrene-olefin polymer; and
(iii) a light weight filler; and

(b) removing the solvent from the liquid coating composition to form a solidified coating on the substrate.

The resultant coating can serve as a waterproofing coating, an air and vapor barrier coating, or an ice and water shield coating for roofing applications. This coating typically has a water vapor permeability in a range from about 0.0001 to about 0.08 perms-inch, when measured at a temperature of 73° F. and a relative humidity of 50%.

In a further aspect, the present invention provides a method for preparing a coating composition containing light weight fillers, the method comprising contacting (e.g., mixing, combining, blending, etc.) an organic solvent, a polymeric binder, and a light weight filler. The polymeric binder comprises a styrene-olefin polymer, but also can contain other polymeric components, such as styrene-based polymers like polystyrene or high impact polystyrene (HIPS). Synthetic fibers and other additives, including pigments, fillers, tackifiers, plasticizers, and the like, also can be employed in the coating compositions disclosed herein.

The above summary of the present invention is not intended to describe each disclosed embodiment or every aspect of the present invention. The detailed description that follows more particularly exemplifies the disclosed aspects and embodiments, but does not limit the scope of the invention, as defined in part by the claims that follow.

### DEFINITIONS

To define more clearly the terms used herein, the following definitions are provided.

The term “polymer,” as used herein, encompasses homopolymers, copolymers, terpolymers, and the like, unless indicated otherwise.

The term “monomer unit” indicates a unit of a polymer, which is derived from, or has the same chemical structure as, a unit derived from a particular monomer.

The term “substrate” includes any material having a surface that is capable of being coated with the compositions of this invention. The substrate can have a smooth or a rough surface, can have cracks, voids, or defects, and can be porous or non-porous.

The term “light weight filler” is used to describe filler materials which have a density or specific gravity less than that of water, i.e., less than 1 g/cm³. Generally, these light weight fillers have a density less than about 0.75 g/cm³.

The terms “a,” “an,” and “the” are intended to include plural alternatives, e.g., at least one. For instance, the disclosure of “an organic solvent” is meant to encompass one, or mixtures or combinations of more than one, organic solvent.

Unless defined otherwise, all technical and scientific terms used herein have the same meaning as commonly understood by one of ordinary skill in the art to which this invention pertains.

Although any methods and materials similar or equivalent to those described herein can be used in the practice or testing of the invention, the typical methods and materials are herein described. Methods recited herein may be carried out in any order that is logically possible, in addition to any particular order disclosed.

Applicants disclose several types of ranges in the present invention. These include, but are not limited to, a range of weight percentages of solvent in the coating composition, a range of weight percentages of polymeric binder in the coating composition, a range of weight percentages of light weight filler in the coating composition, a range of weight percentages of synthetic fibers in the coating composition, a range of densities of the coating composition, a range of densities of the light weight filler, a range of VOC levels of the coating composition, a range of coating thicknesses, a range of water vapor permeabilities of the coating, and so forth. When Applicants disclose or claim a range of any type, Applicants' intent is to disclose or claim individually each possible number that such a range could reasonably encompass, including end points of the range as well as any sub-ranges and combinations of sub-ranges encompassed therein. For example, by a disclosure that the weight percent of the organic solvent in a coating composition is in a range from about 40 to about 60 percent, Applicants' intend to recite that the weight percent of the organic solvent can be selected from about 40 percent, about 41 percent, about 42 percent, about 43 percent, about 44 percent, about 45 percent, about 46 percent, about 47 percent, about 48 percent, about 49 percent, about 50 percent, about 51 percent, about 52 percent, about 53 percent, about 54 percent, about 55 percent, about 56 percent, about 57 percent, about 58 percent, about 59 percent, or about 60 percent. Additionally, the weight percent of the organic solvent in the coating composition can be can be within any range from about 40 percent to about 60 percent (for example, about 45 percent to about 55 percent), and this also includes any combination of ranges between about 40 percent and about 60 percent (for example, about 40 to about 45 percent, and about 55 to about 58 percent). Likewise, all other ranges disclosed herein should be interpreted in a manner similar to this example.

Applicants reserve the right to proviso out or exclude any individual members of any such range, including any sub-ranges or combinations of sub-ranges within the stated range, that can be claimed according to a range or in any similar manner, if for any reason Applicants choose to claim less than the full measure of the disclosure, for example, to account for a reference that Applicants may be unaware of at the time of the filing of the application.

While compositions, articles, and methods are described in terms of “comprising” various components or steps, these compositions, articles, and methods can also “consist essentially of” or “consist of” the various components or steps.

### DETAILED DESCRIPTION OF THE INVENTION

The present invention is directly generally to coating compositions, methods for preparing the coating compositions, methods for using the compositions to coat substrates, and coated articles produced from these coating compositions. In particular, the present invention discloses solvent-based coating compositions containing light weight fillers. Such compositions can be employed as a waterproofing coating, and often have reduced VOC levels. According to one aspect of this invention, the coating composition comprises:

(i) an organic solvent;

(ii) a polymeric binder comprising a styrene-olefin polymer; and

(iii) a light weight filler.

In another aspect, coating compositions of the present invention have a density or specific gravity below that typically found in solvent-based coatings and/or waterproofing compositions available in the industry. For example, coating compositions disclosed herein generally have a density below about 8 lbs/gallon, such as, for example, in a range from about 4 to about 8 lbs/gallon.

According to another aspect of this invention, a method for coating a substrate is provided. The substrate can be a rigid structural unit, to be discussed further below. One such method of coating a substrate in accordance with the present invention can comprise:

(a) applying a liquid coating composition to the substrate, wherein the liquid coating composition comprises:
(i) an organic solvent;
(ii) a polymeric binder comprising a styrene-olefin polymer; and
(iii) a light weight filler; and

(b) removing the solvent from the liquid coating composition to form a solidified coating on the substrate.

### Rigid Structural Units

Substrates that can be coated in the present invention can comprise a “rigid structural unit.” This term includes, by way of example, foundations, basement walls, retaining walls, cement posts, other building walls, dry wall, pool enclosures, tub and shower enclosures, highway structures (e.g., posts and walls), wooden or metal fence posts, sheet rock, plywood, wafer board, wall sheeting, pressed board, containment basins and walls, fabricated walls, floor panels, roofs, plaza decks, decks, floors, concrete, pre-stressed concrete, other substrates that are buried or are exposed to water or weathering conditions, and the like. These rigid structural units are typically made from masonry, cement, wood, plaster, stone, gypsum, clay, brick, tile, terra cotta, cardboard, paper, and the like, or combinations thereof. Masonry structures, for instance, may or may not comprise reinforcing bars, rod, mesh, and similar materials. In one aspect of this invention, the rigid structural unit being coated comprises masonry or concrete. Alternatively, the rigid structural unit can comprise wood, metal, or gypsum. Generally, gypsum is present in the form of gypsum board, and one or both of the sides of the gypsum board can contain paper or synthetic fibers.

These rigid structural units also can have defects which require filling prior to coating. Such defects can be cracks and fissures, and they can be a result of, for example, concrete form ties or cold joints in concrete. Coating compositions of this invention are useful as coatings on rigid structural units which are less flexible than that of the coating. The coating generally is more flexible and elastic than the substrate to be coated, so movement of that substrate after application of the coating will not cause cracks in the coating.

Generally, there is no limitation on the alignment or positioning of the rigid structural unit and whether it can benefit from coatings of the present invention. For instance, the rigid structural unit often is positioned vertically, such as in walls (e.g., basement walls, retaining walls, wall framing, gypsum or sheet rock walls, etc.) or posts (e.g., cement, wood, metal, etc.). Rigid structural units which can be coated in this invention also can be aligned horizontally. Horizontal structural units include, for example, floors, decks, and flat roofs.

### Polymer Binder Component

The polymer component of the coating composition contains a styrene-olefin polymer. This encompasses polymers having olefin (e.g., ethylene) and/or di-olefin (e.g., isoprene) monomers. For instance, suitable styrene-olefin polymers include, but are not limited to, styrene-ethylene-butylene, styrene-ethylene-propylene, styrene-ethylene-propylene-styrene, styrene-butadiene-styrene, styrene-isoprene-styrene, styrene-ethylene-butylene-styrene, and the like, or combinations thereof. Olefin monomer units can include ethylene, propylene, butylene, butadiene, and isoprene, the latter two being di-olefins or dienes.

Some styrene-olefin polymers, such as styrene-diene (di-olefin) polymers, have a styrene content of less than 60 weight percent. Exemplary styrene-olefin polymers of this type having di-olefin or diene monomer units include a styrene-diene-styrene triblock copolymer, having two endblocks of polymerized styrene monomer units, separated by a central block of polymerized diene monomer units. Suitable triblock polymers include, for example, styrene-butadiene-styrene (S-B-S) polymers and styrene-isoprene-styrene (S-I-S) polymers. Commercial S-B-S and S-I-S polymers include many of the Kraton® D 1100 Series polymers and Stereon® Block Copolymers from Firestone Synthetic Rubber & Latex Co. (Akron, Ohio). For example, Kraton® D 1101 and D 1102 are S-B-S polymers and Kraton® D 1107 is an S-I-S polymer. These polymers typically have a styrene content in the range from about 5 to about 60 weight percent, and often from about 10 to about 35 percent.

Another example of a suitable styrene-diene copolymer is a styrene-diene diblock polymer, such as a styrene-butadiene (S-B) copolymer or a styrene-isoprene (S I) copolymer. Commercially available triblock polymers often include at least some diblock polymer.

Other non-limiting examples of styrene-olefin polymers that can be present in the polymeric binder component include styrene-ethylene-butylene-styrene (S-EB-S) block polymers, styrene-ethylene-propylene-styrene (S-EP-S) block polymers, styrene-ethylene-butylene (S-EB) block polymers, and styrene-ethylene-propylene (S-EP) block polymers. These polymers are available as Kraton® G 1600 and 1700 series polymers, and Kraton® FG 1900 series polymers, for example. In one aspect of this invention, the styrene-olefin polymer is a styrene-ethylene-butylene-styrene polymer, such as, for example, a Kraton® G 1600 Series polymer, including Kraton® G 1650 and 1652 polymers, or Calprene® 6120. These styrene-olefin polymers often have styrene contents ranging from about 10 to about 60 weight percent, for example, from about 20 to about 50 weight percent, or from about 25 to about 40 weight percent. Such polymers combine the hardness of the styrene monomer units with the flexibility and elastomeric properties of the olefin monomer units.

The polymeric binder component of the coating composition comprises a styrene-olefin polymer, but can contain other polymers, often styrene-based polymers. The additional styrene polymer used in combination with the styrene-olefin polymer can be a polystyrene (i.e., styrene homopolymer), a medium impact polystyrene (MIPS), or a high impact polystyrene (HIPS). Generally, the styrene-based polymer component has a styrene content of greater than about 60 weight percent, or alternatively, greater than about 80 weight percent. It is generally believed that the hardness and durability of the coating composition can be improved by including a polymer component having a relatively high styrene content, such as, for example, polystyrene homopolymer, high impact polystyrene (HIPS), or medium impact polystyrene (MIPS). Both HIPS and MIPS are often copolymers of styrene and a diene, such as butadiene. Typically, HIPS has a styrene content of at least about 85 weight percent, and more often, at least about 90 weight percent. Typically, MIPS has a styrene content of at least about 85 weight percent, for example, at least about 95 weight percent. An illustrative commercially available polystyrene that can be employed in this invention is HiVal 5308L (Ashland Specialty Chemical Co., Columbus, Ohio), having a melt flow rate of 9 g/10 min and a density of 1.04 g/cm³.

Additionally, the polymeric component can include a polyolefin. Illustrative examples of polyolefins include polyethylene, polypropylene, and polybutene. In some aspects of this invention, the polymeric binder further comprises a polyethylene, polypropylene, polybutene, polyisobutylene, or a polymer having a combination of butylene and isobutylene monomer units (e.g., a polymer having about 25 to about 30 weight percent of isobutylene monomer units and about 70 to about 75 weight percent of butylene monomer units). Such polyolefins may be obtained from a variety of manufacturers and distributors.

In addition, rubbery polymers can be used in the coating composition. These include, for example, unvulcanized natural rubber, chlorinated natural rubber, chlorinated sulfonated polyethylene rubber, styrene-butadiene rubber, polybutene rubber, chlorinated paraffin, and the like, or combinations thereof.

In some aspects of this invention, the polymeric binder component contains only styrene-olefin polymers. In other aspects, when polymers in addition to a styrene-olefin polymer are employed in the polymeric binder component of the coating composition, the weight percent of the styrene-olefin polymer in the polymeric binder usually falls within a range from about 25 to about 95 percent, or from about 45 to about 95 percent, based on the total weight of the polymeric binder component. For example, the weight percent of the styrene-olefin polymer in the polymeric binder is in a range from about 50 to about 90 percent, or from about 60 to about 80 percent, in some aspects of this invention.

Generally, the weight percentage of the polymeric binder component in the coating composition ranges from about 4 and about 25 percent. In one aspect of the present invention, the weight percent of the polymeric binder, based on the weight of the coating composition, is in a range from about 6 to about 20 percent. In another aspect, the weight percent of the polymeric binder is in a range from about 8 to about 18 percent. Yet, in another aspect, the weight percent of the polymeric binder is in a range from about 10 to about 16 percent.

### Solvents

The polymers and resins that form the polymeric binder component of the coating composition are dissolved and/or dispersed in an organic solvent to form a coating composition. The amount of solvent used affects the drying time and the appropriate method of application for the coating composition. A variety of solvents may be used. Suitable solvent types that are contemplated include, for example, aromatic hydrocarbons, cycloaliphatic hydrocarbons, terpenes, unsaturated hydrocarbons, organic carbonates, and halogenated aliphatic and aromatic hydrocarbons. Non-limiting examples of useful organic solvents include toluene, xylene, benzene, halogenated benzene derivatives, ethyl benzene, naphtha, cyclohexane, methylene chloride, ethylene chloride, trichlorethane, chlorobenzene, ethylene carbonate, nitropropane, acetone, ethyl acetate, propyl acetate, butyl acetate, isobutyl isobutyrate, and the like, or combinations thereof. In accordance with one aspect of this invention, the organic solvent is an aromatic hydrocarbon solvent, and in particular, the aromatic hydrocarbon solvent can be benzene, xylene, toluene, ethyl benzene, a halogenated benzene derivative, or combinations thereof. Mineral spirits and alcohols also can be used as diluents in combination with an organic solvent.

For environmental reasons and to reduce VOC levels, it is desirable to use as little solvent as possible in the coating composition. The lower limit on the amount of solvent may be determined by the amount of solvent needed to solvate and/or disperse the components of the coating composition. If too little solvent is used, then the coating composition may be too viscous for a particular application method. On the other hand, if too much solvent is used, the coating composition may not have the necessary viscosity to ensure that a proper coating is deposited on the structural unit, and further, an excessive amount of VOC's may be emitted. This can result in a coating which is thin, easily punctured, and/or has an unacceptable amount of pinholing. In addition to the use of a solvent, the viscosity of a coating composition can be reduced by applying heat to the coating composition.

The desired viscosity of the coating composition often depends on the method of application of the coating composition. Coating compositions that are formulated for application using a brush or roller are generally more viscous than those formulated for spraying. The desired viscosity also may depend on whether the substrate to be coated is a horizontal structural unit or a vertical structural unit, considering that a less viscous coating composition may run on a vertically aligned substrate.

The amount of solvent in the coating composition can range from about 30 to about 70 weight percent, based on the total weight of the coating composition. For instance, the weight percent of the organic solvent in the coating composition is in a range from about 35 to about 65 percent, or from about 40 to about 60 percent, in some aspects of this invention. Further, it is contemplated that the weight percent of the organic solvent in the coating composition can fall within the narrower range of from about 45 to about 55 percent in other aspects of this invention.

### Light Weight Fillers

Another component of the coating composition is a light weight filler. As noted above, a light weight filler has a density that is less than 1 g/cm³. This is in contrast to many inorganic fillers, such as clay and calcium carbonate, which have densities much greater than 1 g/cm³. Often, light weight fillers of this invention have a density between about 0.05 g/cm³ and about 0.8 g/cm³, such as, for example, a density in the range from about 0.05 to about 0.75 g/cm³, from about 0.05 to about 0.7 g/cm³, from about 0.1 to about 0.6 g/cm³, or from about 0.1 to about 0.5 g/cm³.

These light weight fillers generally are present in the coating composition in a range from about 1 to about 12 weight percent, based on the total weight of the coating composition. In some aspects of this invention, the weight percent of the light weight filler in the coating composition is in a range from about 2 to about 10 percent. In other aspects, the light weight filler is present in the coating composition at a weight percentage in the range from about 2 to about 8 percent.

In one aspect of this invention, the light weight filler can comprise microspheres. These microspheres have particles sizes that fall generally within a range from about 5 to about 200 microns. Average or mean particle size of the microspheres is often in the range of about 10 to about 100 microns. For instance, some microspheres that are useful in the present invention have an average particle size in the 40 to 90 micron range. It is conceivable that the size of the microsphere employed can vary depending upon the thickness of the coating desired.

In another aspect, the light weight filler comprises microspheres, and these microspheres can be hollow glass microspheres, hollow polymeric microspheres, or a mixture of these materials. In addition to glass, hollow microspheres can be composed of carbon, graphite, zinc, and ceramic materials. An illustrative and non-limiting example of hollow glass microspheres is Extendospheres® KLS, having a density of approximately 0.4 g/cm³, and containing about 80 weight percent glass (oxide), about 20 weight percent mullite, and less than 5 weight percent crystalline silica (quartz). Q-Cel® hollow microspheres, which contain sodium borosilicate, also can be used. Exemplary Q-Cel® hollow microsphere products include 5019 (0.1 g/cm³), 6036 (0.18 g/cm³), 6048 (0.29 g/cm³), and the like. Hollow polymeric microspheres can be formed from polymers such as acrylic, acrylonitrile, polyvinyl chloride, polyvinylidene chloride, polystyrene, and the like. The hollow polymeric microspheres employed in the inventive coating compositions disclosed herein are not limited to any particular polymer, provided that the polymer of which the microsphere is composed is chemically-resistant to the organic solvent used in the coating composition.

### Fillers

Fillers disclosed in this section differ from the light weight fillers discussed immediately above. The coating compositions of this invention typically include a filler. The filler may increase the strength of the coating composition and/or replace more expensive components, such as the polymeric binder component. The filler also can modify the physical properties of the coating composition and coatings formed from the coating composition, including, for example, the color, opacity, affinity for other coatings, density, rheology, stiffness, and modulus of the coating composition and/or coating. Any particular filler may have one or more of these, or other, functions in the coating composition.

In addition, a coating composition with a filler may more easily and reliably cover holes, depressions, recesses, cracks, and crevices in a substrate, for example, in masonry blocks, concrete, wood, and other porous or rough substrates. The presence of a filler may reduce the size and number of pinholes in a coating formed from the coating composition. These pinholes arise, at least in some cases, because of gravity and/or capillary action that draws the coating composition into the hole, depression, recess, crack, or crevice in the substrate, creating a break or pinhole in the resulting solidified coating. The filler often includes particles that, because of their larger size, provide structural support that, in combination with the polymeric component, form a coating across or fill the hole, depression, recess, crack, or crevice. This reduces the tendency to form pinholes in the coating.

Suitable fillers include, for example, carbonates (e.g., calcium carbonate), clays, talcs, silicas including fumed silica and amorphous silica, silico-aluminates, aluminum hydrate, metal oxides (e.g., oxides of aluminum, iron, zinc, magnesium, and titanium), silicates (e.g., mica), sand, Portland cement, carbon filaments, glass, fiberglass, cellulose, graphite, mortar powder, sulfates (such as magnesium or calcium sulfates), and the like, or combinations thereof. Within the general class of fillers, pigments are used to provide a color or tint to the coating composition and resultant coating, generally for aesthetic purposes. Common pigments include such materials as titanium dioxide (white) and carbon black (black), and these can be used in combination.

The amount of a particular filler in the coating composition typically depends on the desired properties of the coating composition. These properties may include the strength, flexibility, ultraviolet radiation resistance, chemical resistance, permeability, and cost of the coating. Combinations of more than one filler are often used to provide a combination of advantageous properties.

### Fibers

A coating composition can comprise (i) an organic solvent; (ii) a polymeric binder comprising a styrene-olefin polymer; and (iii) a light weight filler. In accordance with another aspect of the present invention, this composition can further comprise synthetic fibers. The synthetic fibers can be manufactured from several commercially available polymers, including polyethylene, polypropylene, polyester, polyamide (nylon), and poly-paraphenylene terephthalamide (Kevlar®). Mixtures or combinations of more than one type of synthetic fiber can be employed in the coating composition. Polyester, polypropylene, and polyethylene fibers (comprising high density polyethylene and/or linear low density polyethylene) are available under the Short Stuff® brand, for instance. Fiber cut lengths in the range from about 0.1 mm to about 25 mm are commonly available, with fiber diameters ranging from about 5 to about 30 microns. For instance, fibers having filament sizes in a range from about 0.5 to about 6 denier per filament can be used in this invention.

In the present invention, it is generally believed that fibers improve the sag resistance of the coating, when applied to vertical structural units, for instance. Typically, the weight percentage of synthetic fibers in the coating composition falls within a range from about 0.05 to about 5 percent. In one aspect, the weight percent of synthetic fibers in the coating composition is in a range from about 0.07 to about 4 percent, such as, for example, from about 0.08 to about 3 percent, or from about 0.09 to about 2 percent. Yet, in another aspect, the weight percent of the synthetic fibers in the coating composition is in a range from about 0.1 to about 1 percent.

### Other Components

The coating composition, optionally, can contain other components. An antioxidant is used to retard the degradation of a polymer. Although many polymers are supplied with an antioxidant, additional antioxidant additives can be added to the coating composition, as needed. For instance, Kraton® Series D 1100 and G 1600 polymers contain an antioxidant incorporated with the polymer. An ultraviolet (UV) absorber or stabilizer can be added to prevent degradation of the coating due to exposure to sunlight or other sources of ultraviolet light. Hindered amine light stabilizers (HALS) are a particularly effective type of UV absorber or stabilizer. Ozone blockers may be used for coating substrates that will be exposed to air or to ozone-forming devices. Non-limiting examples of ozone blockers include dibutyl thiourea, nickel dibutyl-dithiocarbomate, and the like.

A plasticizer also can be present in the coating composition, either as a liquid or solid, to increase the flexibility of the solidified coating. In many cases, a plasticizer is not needed, as a combination of the polymers in the polymeric component can plasticize each other. However, when desired or needed, an additional plasticizer may be added to the coating composition. Examples of useful plasticizers include butyl stearate, dibutyl maleate, dibutyl phthalate, dibutyl sebecate, diethyl malonate, dimethyl phthalate, dioctyl adipate, dioctyl phthalate, butyl benzyl phthalate, benzyl phthalate, octyl benzyl phthalate, ethyl cinnamate, methyl oleate, tricresyl phosphate, trimethyl phosphate, tributyl phosphate, trioctyl adipate phthalate esters, and the like. Other secondary plasticizers are known, such as chlorinated paraffins, polyethylene wax, polybutenes, isoprenes, and flexible rubber compounds. One skilled in the art can select the type of plasticizer and the properties needed in the plasticizer to modify the coating composition and the resultant solidified coating. For instance, Indopol® L-50, an isobutylene/butene copolymer with a density of about 0.85 g/cm³, can be employed as a plasticizer.

A tackifier can be incorporated into the coating composition to improve wetting of, and adhesion to, the substrate. For example, illustrative tackifiers include the low molecular weight C₅ resins with low softening points commercially available as Wingtack® 95 (Sartomer Co., Exton, Pa.) or Piccotac® 1095 (Eastman Chemical Co., Kingsport, Tenn.).

### Coating Composition and its Preparation

In accordance with one aspect of the present invention, a coating composition is provided which comprises:

(i) an organic solvent;

(ii) a polymeric binder comprising a styrene-olefin polymer; and

(iii) a light weight filler.

The coating composition can be used in various end-use coating applications, and these can include, but are not limited to, a waterproofing coating, an air and vapor barrier coating, or an ice and water shield coating composition for roofing applications. In some aspects of this invention, the coating composition can further comprise synthetic fibers. Yet, in other aspects, the coating composition can further comprise an additive selected from a pigment, a filler, a tackifier, a plasticizer, or combinations thereof.

The coating composition is solvent-based, containing about 30 to about 70 weight percent of an organic solvent. Water can be present in the composition, and if present, at very low concentrations. The coating composition does not require the presence of water. For example, the coating composition can contain water, but generally no more than about 5 weight percent in the coating composition. Alternatively, the weight percent of water in the coating composition is less than about 2 percent, less than about 1 percent, less than about 0.5 percent, or less than about 0.1 percent. In one aspect of this invention, the coating composition is free of water.

As compared to commercially available coating compositions, the inventive coating compositions disclosed herein have lower densities. This is due, in part, to the light weight filler component of the coating composition. Accordingly, coating compositions of the present invention typically have a density in a range from about 4 to about 8 lbs/gallon. Often, the density of the coating composition is in a range from about 4.5 to about 7.8 lbs/gallon, from about 5 to about 7.4 lbs/gallon, from about 5.5 to about 7.2 lbs/gallon, or from about 6 to about 7 lbs/gallon.

The solvent-based coating compositions of this invention also can have reduced VOC levels. For instance, the VOC level of the coating composition can be less than about 500 g/L, such as within a range from about 300 to about 500 g/L. In another aspect, the VOC level of the coating composition is in range from about 300 to about 475 g/L, from about 300 to about 450 g/L, or from about 300 to about 425 g/L. The VOC level of the coating composition is in a range from about 300 to about 400 g/L in yet another aspect of the present invention.

A coating composition in accordance with different aspect of this invention can be used as a waterproofing coating composition. This composition comprises the following components and their respective weight percentages:

(i) about 30 to about 70 percent of an organic solvent;

(ii) about 4 to about 25 percent of a polymeric binder comprising a styrene-olefin polymer;

(iii) about 1 to about 10 percent of a light weight filler;

(iv) about 0.05 to about 5 percent of synthetic fibers;

(v) about 1 to about 6 percent of a pigment;

(vi) about 0.5 to about 5 percent of a filler;

(vii) about 5 to about 15 percent of a tackifier; and

(viii) about 4 to about 12 percent of a plasticizer.

Coating compositions disclosed herein can be prepared by combining an organic solvent, a polymeric binder, and a light weight filler. The polymeric binder comprises a styrene-olefin polymer, but also can contain other polymeric components, such as a styrene-based polymer like polystyrene or HIPS. Synthetic fibers and other additives, including pigments, fillers, tackifiers, plasticizers, and the like, or combinations of these materials, also can be incorporated into the coating composition. The order of addition of the various components is not critical to the resulting coating composition and, therefore, all variations in the order of mixing and combining the components is within the scope of this invention.

### Application of the Coating Composition

Substrates, such as rigid structural units, can be coated with the coating compositions of this invention. One such method of coating a substrate comprises:

(a) applying a liquid coating composition to the substrate, wherein the liquid coating composition comprises:
(i) an organic solvent;
(ii) a polymeric binder comprising a styrene-olefin polymer; and
(iii) a light weight filler; and

(b) removing the solvent from the liquid coating composition to form a solidified coating on the substrate.

The coating composition can be applied to the substrate by a variety of techniques, including, for example, rolling, brushing, spraying, squeeging, backrolling, pouring, troweling, and the like. Often, the method of applying the coating composition is spraying the coating composition onto the substrate. Combinations of these techniques also may be used, including spraying the coating composition on the substrate or structural unit, and then rolling or brushing the sprayed coating composition to obtain a more uniform coating. The coating composition may be used on both interior and exterior surfaces of substrates.

The solvent is removed from the liquid coating composition to form a solid coating on the substrate. The time necessary for solvent removal, or drying, can vary significantly depending upon the thickness of the applied coating composition, the air temperature and humidity, and the amount of solvent to be removed. Hence, drying times often can range from less than 1 hour to 24 hours or more.

Once the solvent has been removed, the solidified coating on the substrate can function as, for example, a waterproofing coating, an air and vapor barrier coating, or an ice and water shield coating for roofing applications. An overcoat layer can be applied onto the solid coating, if required.

The thickness of the solid or solidified coating often depends on the particular substrate or structural unit material, its surface characteristics, as well as the environmental conditions, such as exposure to moisture. Substrates with rougher surfaces and substrates in areas subject to higher relative humidity may require a thicker coating. In addition, thicker coatings may be used in situations where the coating is prone to puncturing. Coating thickness also depends, in part, on the desired end-use of the structural unit. Therefore, the thickness range contemplated for solidified coatings produced in this invention is relatively broad, covering coating thicknesses ranging from about 5 mils to about 100 mils. For instance, the dry coating produced by this invention can have a thickness in a range from about 6 to about 40 mils.

Imperfections and damage in the resulting dried coating can be repaired simply by the application of additional liquid coating composition over the area to be repaired. The solvent carrier in the liquid coating re-melts the underlying solidified coating, and the repaired area subsequently dries to form a continuous coating. This is in contrast to prior art systems and most paints, which form additional layers with repeated applications.

Solid coatings of this invention have a water vapor permeability which falls generally within a range from about 0.0001 to about 0.08 perms-inch, when measured at a temperature of 73° F. and a relative humidity of 50%. In one aspect, the coating has a water vapor permeability in a range from about 0.0005 to about 0.08 perms-inch, from about 0.001 to about 0.08 perms-inch, or from about 0.002 to about 0.08 perms-inch. These permeability values are normalized, in that they are not thickness dependent—permeance decreases as the coating thickness increases, and is measured in perms, the units of which are grains/hr-ft²-in Hg. Permeability data is measured in accordance with ASTM E96-90.

The present invention also encompasses coated articles obtained by coating a substrate in accordance with the following method:

(a) applying a liquid coating composition to the substrate, wherein the liquid coating composition comprises:
(i) an organic solvent;
(ii) a polymeric binder comprising a styrene-olefin polymer; and
(iii) a light weight filler; and

(b) removing the solvent from the liquid coating composition to form a solidified coating on the substrate.

These coated articles can comprises various materials, for instance, rigid structural units of varying compositions. Accordingly, the coated article can comprise masonry, concrete, wood, metal, or gypsum, and the like, or combinations thereof.

### EXAMPLES

The invention is further illustrated by the following examples, which are not to be construed in any way as imposing limitations to the scope of this invention. Various other aspects, embodiments, modifications, and equivalents thereof which, after reading the description herein, may suggest themselves to one of ordinary skill in the art without departing from the spirit of the present invention or the scope of the appended claims.

### Examples 1-5

### Coating Compositions Containing Light Weight Fillers

Several gallons of the coating compositions of Examples 1-5 were prepared using the components and respective amounts listed in Table I. The following general procedure was used. Xylene was added to a mixing vessel at the desired weight percentage. The HiVal polystyrene, Wingtac® 95 tackifier, and the Indopol® L-50 plasticizer were added to the xylene at their respective quantities. Once dissolved, the remaining materials were added while mixing in the following order: Calprene® 6120, Bentone 38, titanium dioxide, carbon black, polyethylene fibers, isopropanol or methanol mixed with water, Nyad® G (wollastinite), Q-Cel® 5019, and Extendospheres® KLS. The introduction of air was minimized during the addition of the various components, for example, by mixing at low speeds.

Each coating composition was sprayed or brushed onto a substrate. The coating composition was allowed to dry to form a solid coating on a substrate, such as a masonry block.

Example 1 served as a control, since it did not contain any light weight fillers. Example 1 had a density of about 8.3 lbs/gallon, and a VOC level of about 525 g/L. Examples 2-5 contained both light weight fillers and polyethylene fibers, as illustrated in Table I. Examples 2-3 provided lower coating composition densities and lower VOC levels than Example 1, however, tensile and elongation strengths of these coatings also were reduced. Examples 4-5 had comparable coating tensile and elongation strengths to that of Example 1, and beneficially, also had lower coating composition densities and lower VOC levels. During laboratory spraying trials, the coating of Example 4 resulted in some air encapsulation, whereas this phenomena was not present in the coating of Example 5.

The properties of the coating composition and resultant coating of Example 5 are listed in Table II. The density of the coating composition of Example 5 was 6.39 lbs/gallon, and the VOC level was 396 g/L.

TABLE I
Coating Compositions of Examples 1-5 (values in weight percent).

| | Example | | | | |
|---|---|---|---|---|---|
| | 1 | 2 | 3 | 4 | 5 |
| Xylene | 52.36 | 52.06 | 52.06 | 50.00 | 49.08 |
| Bentone 38 | 1.60 | 1.60 | 1.60 | 1.60 | 1.57 |
| Methanol or isopropanol | 0.25 | 0.25 | 0.25 | 0.25 | 0.25 |
| Water | 0.01 | 0.01 | 0.01 | 0.01 | 0.01 |
| Calprene ® 6120 | 10.45 | 10.14 | 10.14 | 13.00 | 12.76 |
| Polystyrene HiVal 5308L | 2.15 | 2.15 | 2.15 | 2.33 | 2.29 |
| Wingtac ® 95 (tackifier) | 9.60 | 9.60 | 9.60 | 10.40 | 10.21 |
| Indopol ® L-50 (plasticizer) | 8.40 | 8.40 | 8.40 | 8.40 | 8.25 |
| Nyad ® G (wollastinite) | 12.85 | — | 9.00 | 5.41 | 6.63 |
| Carbon black tint | 0.13 | 0.13 | 0.13 | 0.13 | 0.13 |
| Titanium Dioxide Ti-Pure ® R-900 | 2.20 | 2.20 | 2.20 | 2.39 | 2.35 |
| Extendospheres ® KLS | — | 8.00 | — | 1.10 | 1.08 |
| Q-Cel ® 5019 | — | 5.00 | 3.96 | 5.00 | 4.91 |
| Polyethylene Fibers | — | 0.50 | 0.50 | 0.50 | 0.49 |

Notes on Table I:
Bentone 38 is a modified organic clay filler, used as a thickening agent.
Calprene ® 6120 is a styrene-ethylene-butylene-styrene polymer, with about 32 weight percent of styrene.
Wingtac ® 95 is a low molecular weight C₅ aliphatic resin, used as a tackifier.
Indopol ® L-50 is an isobutylene/butene copolymer, used as a plasticizer.
Nyad ® G (wollastinite) is a calcium silicate, used as an inorganic filler.
Extendospheres ® KLS are hollow microspheres with a density of approximately 0.4 g/cm³.
Q-Cel ® 5019 are hollow microspheres with a density of approximately 0.1 g/cm³.
The polyethylene fibers had a filament size of 6 denier per filament and a cut length of 1/16″ (approximately 1.5 mm).

TABLE II
Properties of the Coating Composition and Solid Coating of Example 5.

| Viscosity - Brookfield # 4 spindle at 5 rpm | 39,626 | cps |
|---|---|---|
| Density - specific gravity | 6.39 | lbs/gallon |
| VOC level | 396 | g/L |
| Tensile - ASTM D412 | 207 | psi |
| Elongation - ASTM D412 | 417% | |
| Permeability - 40 mils, after 3 weeks | 0.2 | perms |
| Hydrostatic Head - with defoamer | 90 | ft |

Note on Table II:
Hydrostatic head was measured after 0.5 weight percent of a silicone-free defoamer for solvent-based systems was added.

### Example 6

### Coating Composition Containing Light Weight Fillers

Example 6 contained the same formulation as Example 5, above, with the exception that 0.5 weight percent of a silicone-free defoamer additive, for solvent-based systems, was used in the formulation, and the xylene content was reduced by 0.5 weight percent. Approximately one-half of the defoamer was added to the xylene with the HiVal polystyrene, Wingtac® 95 tackifier, and the Indopol® L-50 plasticizer. After all the remaining components were introduced, the remainder of the defoamer was added. The defoamer additive was used to release air that was entrapped during mixing.

We claim:

1. A coating composition comprising:
(i) an organic solvent;
(ii) a polymeric binder comprising a styrene-olefin polymer; and
(iii) a light weight filler.

2. The composition of claim 1, wherein the organic solvent comprises an aromatic hydrocarbon solvent.

3. The composition of claim 1, wherein the styrene-olefin polymer is a styrene-ethylene-butylene polymer, a styrene-ethylene-propylene polymer, a styrene-ethylene-propylene-styrene polymer, a styrene-butadiene-styrene polymer, a styrene-isoprene-styrene polymer, a styrene-ethylene-butylene-styrene polymer, or any combination thereof.

4. The composition of claim 1, wherein the polymeric binder further comprises a styrene polymer selected from a polystyrene, a medium impact polystyrene, a high impact polystyrene, or any combination thereof.

5. The composition of claim 1, wherein the light weight filler comprises microspheres.

6. The composition of claim 1, wherein the light weight filler comprises hollow glass microspheres, hollow polymeric microspheres, or a mixture thereof.

7. The composition of claim 1, wherein the light weight filler has a density in a range from about 0.05 to about 0.75 g/cm³.

8. The composition of claim 1, further comprising synthetic fibers.

9. The composition of claim 8, wherein the synthetic fibers comprise polyethylene, polypropylene, polyester, polyamide, poly-paraphenylene terephthalamide, or any combination thereof.

10. The composition of claim 1, further comprising an additive selected from a pigment, a filler, a tackifier, a plasticizer, or any combination thereof.

11. The composition of claim 1, wherein the composition is free of water.

12. The composition of claim 1, wherein the composition has a density in a range from about 4 to about 8 lbs/gallon.

13. The composition of claim 1, wherein the composition has a volatile organic content (VOC) level in a range from about 300 to about 500 g/L.

14. A method of coating a substrate, the method comprising:
(a) applying a liquid coating composition to the substrate, wherein the liquid coating composition comprises:
(i) an organic solvent;
(ii) a polymeric binder comprising a styrene-olefin polymer; and
(iii) a light weight filler; and
(b) removing the solvent from the liquid coating composition to form a solidified coating on the substrate.

15. The method of claim 14, wherein the substrate comprises a rigid structural unit.

16. The method of claim 15, wherein the rigid structural unit comprises masonry or concrete.

17. The method of claim 15, wherein the rigid structural unit comprises wood, metal, or gypsum.

18. The method of claim 14, wherein the solidified coating has a water vapor permeability in a range from about 0.0001 to about 0.08 perms-inch at a temperature of 73° F. and a relative humidity of 50%.

19. A coated article obtained by the method of claim 14.

20. The coated article of claim 19, wherein the coated article comprises masonry, concrete, wood, metal, gypsum, or combinations thereof.
